(19) United States
(12) Patent Application Publication
(10) Pub. No.: US 2019/0107622 A1
(43) Pub. Date: Apr. 11, 2019

(54) Scanning LiDAR System and Method with Source Laser Beam Splitting Apparatus and Method

(71) Applicant: Veoneer US, Inc., Southfield, MI (US)

(72) Inventor: Mauritz Andersson, Ogden, UT (US)

(73) Assignee: Veoneer US, Inc., Southfield, MI (US)

(21) Appl. No.: 15/730,242

(22) Filed: Oct. 11, 2017

(51) Int. Cl. G01S 17/08

(52) U.S. Cl. CPC G01S 17/08

(57) ABSTRACT

A LiDAR detection system includes a beam splitting device which generates a plurality of mutually parallel output beams of light from a first beam of light. The beam splitting device comprises a first surface reflecting a first portion of the first beam of light toward a second surface and transmitting a second portion of the first beam through a first position of the first surface such that the second portion of the first beam becomes one of the plurality of second beams of light, the first portion of the first beam of light being reflected from the second surface toward the first surface. A scanning device scans the plurality of second beams of light over a second direction different than the first direction.

### BACKGROUND

### 1. Technical Field

The present disclosure is related to LiDAR detection systems and, in particular, to a scanning LiDAR system and method with an apparatus and method for splitting a LiDAR illumination source laser beam.

### 2. Discussion of Related Art

A typical LiDAR detection system includes a source of optical radiation, for example, a laser, which emits light into a region. An optical detection device, which can include one or more optical detectors and/or an array of optical detectors, receives reflected light from the region and converts the reflected light to electrical signals. A processing device processes the electrical signals to identify and generate information associated with one or more target objects in the region. This information can include, for example, bearing, range and/or velocity information for each target object.

One very important application for LiDAR detection systems is in automobiles, in which object detections can facilitate various features, such as parking assistance features, cross traffic warning features, blind spot detection features, autonomous vehicle operation, and many other features. In automotive LiDAR detection systems, it is important to be able to detect both bright objects at close range and low-reflectivity objects at long range with the same system configuration.

### SUMMARY

According to one aspect, a LiDAR detection system is provided. An optical source provides a first beam of light. A beam splitting device receives the first beam of light and generates a plurality of second beams of light from the first beam of light, the plurality of second beams of light being disposed along a first lateral direction and being transmitted into a region. The beam splitting device comprises a first surface and a second surface, the first surface reflecting a first portion of the first beam of light toward the second surface and transmitting a second portion of the first beam through a first position of the first surface such that the second portion of the first beam becomes one of the plurality of second beams of light, the first portion of the first beam of light being reflected from the second surface toward the first surface, the first surface splitting the first portion of the first beam of light into third and fourth portions, the first surface reflecting the third portion toward the second surface and transmitting the fourth portion through a second laterally shifted position of the first surface such that the fourth portion becomes another of the plurality of second beams of light. A scanning device scans the plurality of second beams of light over a second direction different than the first direction. A receiver receives reflected optical signals generated by reflection of one or more of the second beams of light and generating receive signals indicative of the reflected optical signals. A processor coupled to the receiver receives the receive signals and processes the receive signals to generate detections of one or more objects in the region.

The first and second surfaces can be substantially parallel. The plurality of second beams of light can be substantially mutually parallel. A propagation axis of the first beam of light can form a tilt angle with the beam splitting device, the tilt angle being selectable to set a predetermined spacing between the plurality of second beams of light. A spacing distance between the first and second surfaces can be selectable to set a predetermined spacing between the plurality of second beams of light.

The reflectivity of the first surface can vary by position on the first surface. The first surface includes a plurality of optical coatings. One or more parameters of the plurality of optical coatings can vary by position to achieve a desired reflectivity variation of the first surface by position on the first surface. The second surface can comprise a first portion that is substantially completely transparent and a second portion that is substantially completely reflective.

The first and second surfaces can be formed on a single substrate. At least one of the first and second surfaces can comprise one or more optical coatings. The single substrate can be substantially optically transparent. The single substrate can comprise glass. The single substrate can also or alternatively comprise fused silica.

The first direction can be substantially orthogonal to the second direction.

The scanning device can comprise a scanning mirror. The scanning mirror can be a micro-electromechanical system (MEMS) scanning mirror.

The receiver can comprise an array of optical detectors. The array of optical detectors can be a two-dimensional array.

The optical source can comprise a laser.

The LiDAR detection system can be an automotive LiDAR detection system.

### BRIEF DESCRIPTION OF THE DRAWINGS

The present disclosure is further described in the detailed description which follows, in reference to the noted plurality of drawings by way of non-limiting examples of embodiments of the present disclosure, in which like reference numerals represent similar parts throughout the several views of the drawings.

FIG. 1 includes a schematic functional block diagram of a conventional scanning LiDAR system.

FIGS. 2A and 2B include schematic functional block diagrams of scanning LiDAR systems, according to some exemplary embodiments.

FIGS. 3A and 3B includes schematic functional block diagrams of scanning LiDAR systems, according to some exemplary embodiments, in which an optical component has a different configuration than that of the systems of FIGS. 2A and 2B.

FIG. 4 includes a detailed schematic view of the optical component illustrated in FIG. 2, according to some exemplary embodiments.

FIG. 5 includes multiple views of the optical component of FIG. 5, according to some exemplary embodiments.

FIG. 6 includes three curves illustrating exemplary: (a) normalized coating reflectivity profile on a top surface of the optical component of FIGS. 4 and 5, (b) normalized beam power remaining after reflection from the top surface, and (c) normalized exit beam power for each of 25 beams generated by the optical component of FIGS. 4 and 5, according to beam number, from 1 to 25, according to some exemplary embodiments.

FIG. 7 includes a schematic perspective view of an automobile equipped with one or more LiDAR systems described herein in detail, according to some exemplary embodiments.

FIG. 8 includes a schematic top view of an automobile equipped with two LiDAR systems as described herein in detail, according to some exemplary embodiments.

### DETAILED DESCRIPTION

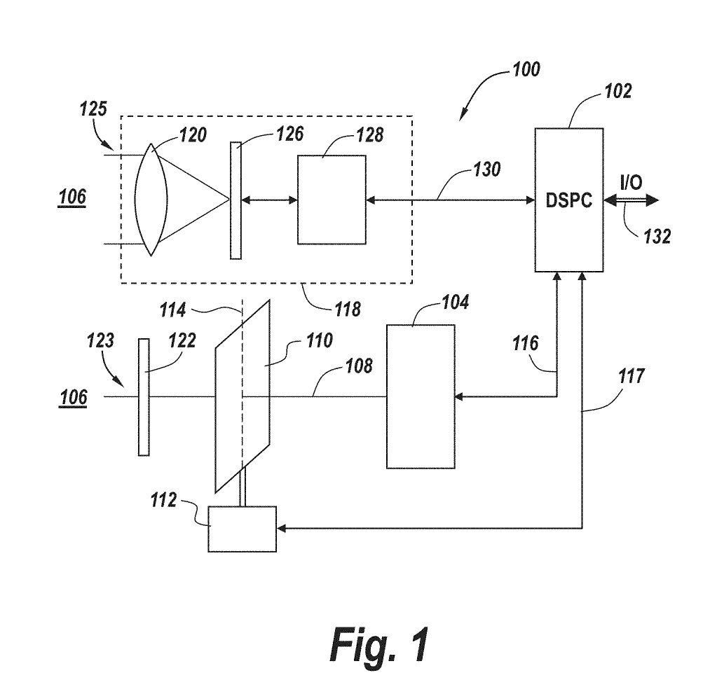

FIG. 1 includes a schematic functional block diagram of a conventional scanning LiDAR system 100. Referring to FIG. 1, system 100 includes a digital signal processor and controller (DSPC) 102, which performs all of the control and signal processing required to carry out the LiDAR detection functionality. An optical source 104 operates under control of DSPC 102 via one or more control signals 116 to generate one or more optical signals transmitted into a region 106 being analyzed. Among other functions, control signals 116 can provide the necessary control to perform wave shaping such as, for example, pulsed frequency-modulated continuous-wave (FMCW) modulation envelope control to produce a pulsed FMCW optical signal. Optical source 104 can include a single laser, or optical source 104 can include multiple lasers, which can be arranged in a one-dimensional or two-dimensional array. One or more optical signals 108 from source 104, which can be, for example, a pulsed FMCW optical signal, impinge on scanning mirror 110, which can be a microelectromechanical system (MEMS) scanning mirror. Scanning mirror 110 is rotatable about an axis 114 by an actuator 112, which operates under control of one or more control signals 117 provided by DSPC 102 to control the rotation angle of scanning mirror 110, such that the one or more output optical signals are scanned at various angles into region 106. The output optical signals pass through a transparent window or plate 122 as one or more collimated optical signals 123, which are scanned across region 106.

Returning optical signals 125 are received from region 106 at receive subsystem 118. Receive subsystem 118 can include a lens 120 which receives and focuses light 125 returning from region 106. The returning light can be focused at optical detector array 126, which converts the received optical signals to electrical signals. A processor 128 generates digital signals based on the electrical signals and transmits the digital signals 130 to DSPC 102 for processing to develop target object identification, tracking and/or other operations. Reports of detections to one or more user interfaces or memory or other functions can be carried out via I/O port 132.

In system 100 of FIG. 1, the single narrow collimated laser beam from which output optical signal 123 is derived can have certain drawbacks. For example, such a system can be sensitive to debris such as dirt, dust and rain, or other optically imperfect surfaces. Also, regarding eye safety considerations, the full beam power may enter an eye, which can cause serious injury. Eye safety requirements of such a system may limit the emitted laser power. According to the present disclosure, a scanning LiDAR system includes an optical component which produces multiple parallel optical illumination beams separated by, for example, more than the pupil diameter from a single input, while also allowing an angular scanning beam. The approach of the disclosure allows robustness to optical blockage of one or several outgoing beams, since, in general, in a blockage event, the majority of outgoing beams will remain undisturbed. Also, the approach of the disclosure allows more laser power while conforming to eye safety regulations.

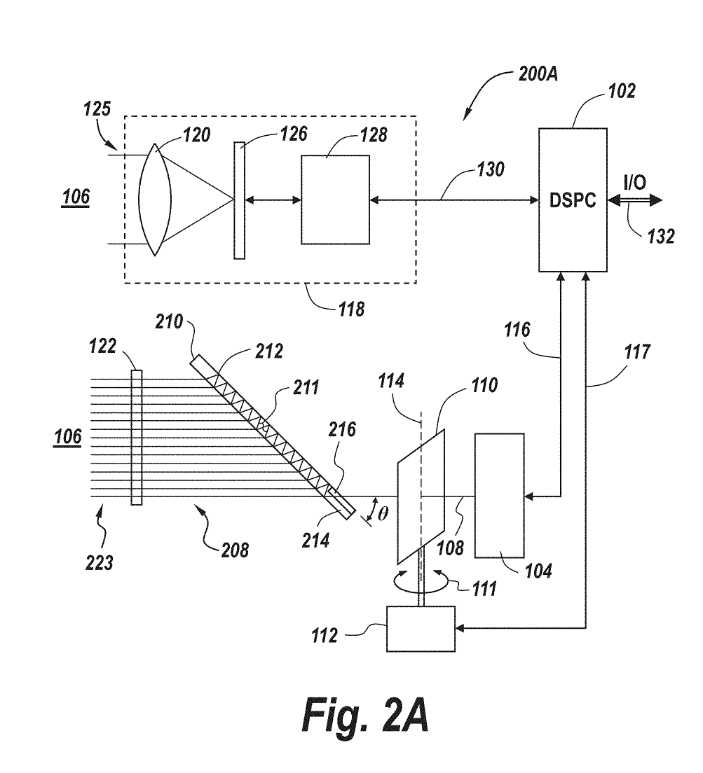

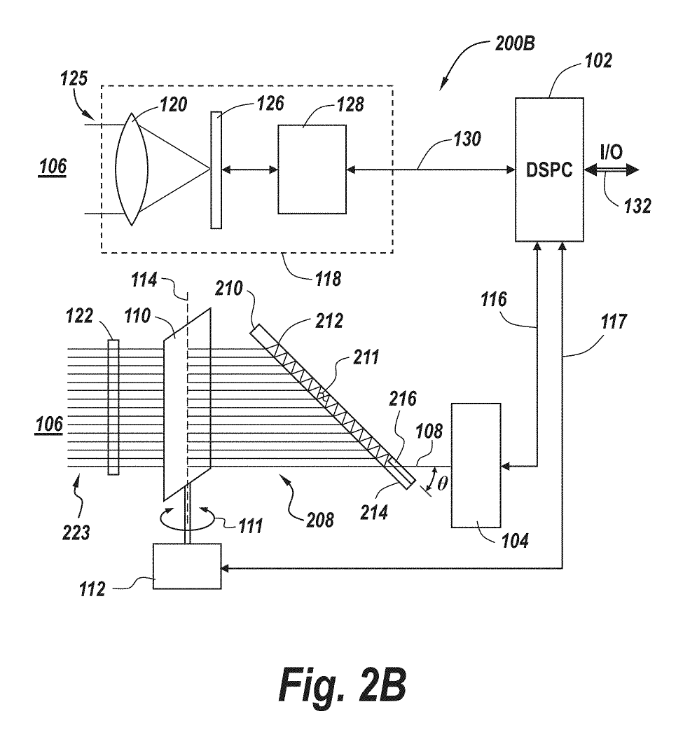

The scanning LiDAR detection system described herein in detail can be of the type described in copending U.S. patent application Ser. No. 15/410,158, filed on Jan. 19, 2017, of the same assignee as the present application, the entire contents of which are incorporated herein by reference. FIGS. 2A and 2B include schematic functional block diagrams of scanning LiDAR systems 200A and 200B, according to some exemplary embodiments. Systems 200A and 200B of FIGS. 2A and 2B are analogous to system 100 of FIG. 1, with certain differences. Like elements in systems 100, 200A and 200B are identified by like reference numerals. Detailed description of like elements will not be repeated herein.

The primary difference between systems 200A and 200B of FIGS. 2A and 2B is in the ordering of the scanning mirrors 110 and beam splitting optical component 210 along the transmission optical path. Referring to FIGS. 2A and 2B, according to the present disclosure, in system 200B, the laser beam output 108 from laser source 104 is transmitted through optical component 210, and the resulting output beams 208 are scanned by scanning mirror 110. In system 200A, laser beam output 108 from laser source 104 is scanned by scanning mirror 110 onto beam splitting optical component 210. Laser beam output 108 has an exemplary diameter of up to 5 mm, and typically has a nominal diameter of approximately 0.5 mm. Optical component 210 splits the laser beam into a number N of substantially parallel, laterally-displaced beams 208. In FIGS. 2A and 2B, N is shown to be 15; but it will be understood that any number N of substantially parallel, laterally-displaced beams can be used. In some exemplary embodiments, each of the N beams 208 has an optical power of approximately 1/N of the optical power of the original single laser beam 108. In some exemplary embodiments, optical component 210 preserves the far-field beam size within appropriate required limits/tolerances. Hence, according to exemplary embodiments, a plurality N of substantially mutually parallel illumination laser beams 208 are laterally displaced along a first dimension or axis, i.e., a vertical y-axis. The resulting one-dimensional array of beams 223 is scanned over region 106 in a second orthogonal dimension or axis, i.e., a horizontal x-axis, orthogonal to the surface of the page in FIGS. 2A and 2B, by angular movement of scanning mirror 110 about axis 114, as illustrated by arrows 111. Thus, optical component 210 enable an angular scanning beam within acceptance limits. Optical component 210 is robust to failure since all included optical elements are passive.

Continuing to refer to FIGS. 2A and 2B, in some exemplary embodiments, optical component 210 can include a body portion 211, which can be made of an optically transparent material such as fused silica, glass, or other such material. Optical component 210 also includes two substantially flat and parallel opposing surfaces 212, 214, which can be implemented by appropriate optical coatings and/or treatments. Output laser light beam 108 from source 104 enters component 210 through a transparent opening or port 216. Surface 214 is partially reflective and, therefore, partially transmits the light toward scanning mirror 110 and partially reflects the light toward reflective surface 212. The light returning to surface 212 is reflected back to surface 214, which again partially transmits the light toward scanning mirror 110 and partially reflects the light back toward surface 212. This continues along surfaces 212, 214 to generate the plurality of mutually substantially parallel beams laterally displaced with respect to each other along the vertical y-axis.

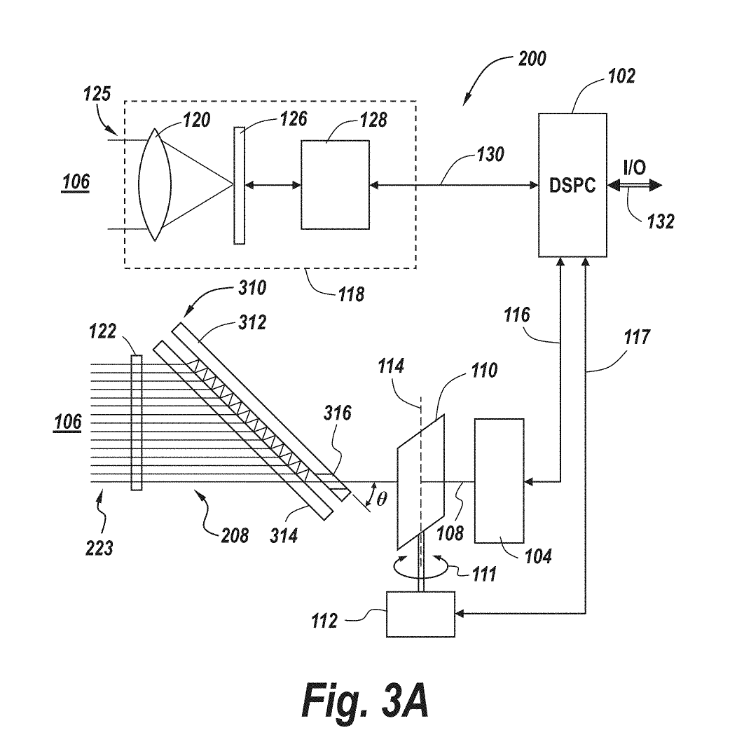

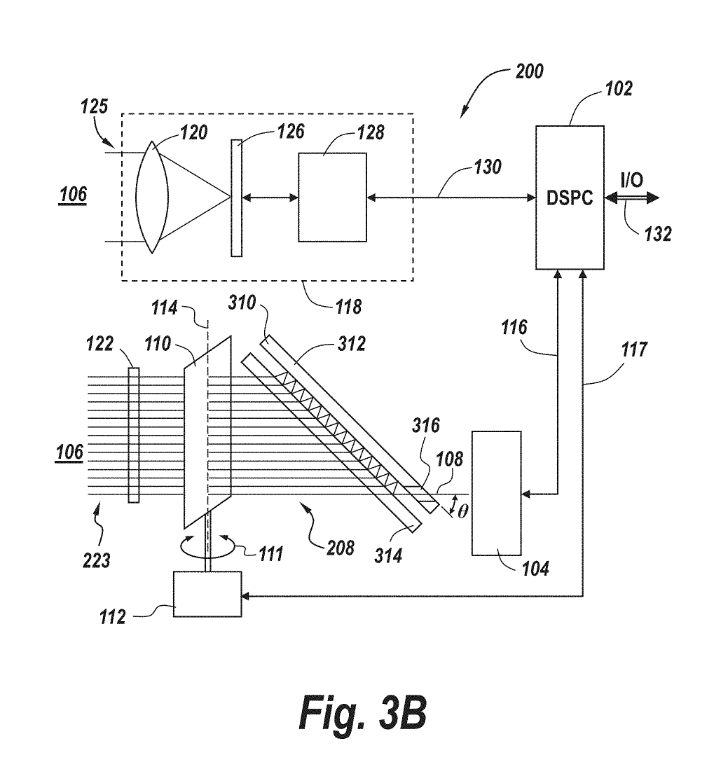

Hence, according to this exemplary embodiment, optical component 210 is a single element including body portion 211 made of a transparent material with a beam splitter coating on one surface 214 and a mirror coating on the other surface 212. By using one solid component 210, the configuration is robust and low cost. However, it will be understood that other alternative embodiments may also be used. FIGS. 3A and 3B include schematic functional block diagrams of scanning LiDAR systems 300A and 300B, according to some exemplary embodiments, in which the optical component has a different configuration than that of systems 200A and 200B of FIGS. 2A and 2B, respectively. Systems 300A and 300B of FIGS. 3A and 3B are analogous to systems 200A and 200B of FIGS. 2A and 2B, with certain differences. Like elements in systems 200A, 200B and 300A, 300B are identified by like reference numerals. Detailed description of like elements will not be repeated herein.

The primary difference between systems 300A and 300B of FIGS. 3A and 3B is in the ordering of the scanning mirrors 110 and beam splitting optical component 310 along the transmission optical path. Referring to FIGS. 3A and 3B, optical component 310 is implemented as two subcomponents, namely, an optical surface 312 in the place of surface 212 in system 200 of FIG. 2, and a specially-coated semi-transparent window or surface 314 in place of surface 214 in system 200 of FIG. 2. The two subcomponents or surfaces 312, 314 are disposed in a plane-parallel configuration. Output laser light beam 108 from source 104 enters component 310 through a transparent opening or port 316 in optical surface 312.

In systems 200A, 200B of FIGS. 2A, 2B and systems 300A, 300B of FIGS. 3A, 3B, optical components 210 and 310, respectively, are configured with a selectable tilt angle θ and a relative placement or spacing of optical surfaces. That is, in systems 200A, 200B of FIGS. 2A, 2B and systems 300A, 300B of FIGS. 3A, 3B, tilt angle θ between optical component 210, 310 and the optical axis of beam 108 can be selected as desired. Similarly, relative placement or spacing of optical surfaces 212, 214 (via selectable thickness of body 211, for example) and optical subcomponents or surfaces 312, 314 is also selectable. This flexibility in tilt angle and placement/spacing of optical surfaces ensures both the acceptance angle and the desired, e.g., optimal, parallel beam displacement. The acceptance angle is the range over incoming tilt angles that the component still produces a sufficiently working array of parallel beams without detrimental optical losses. The incoming laser beam 108 direction is preserved to the outgoing direction of output beams 208 toward region 106 over a range of tilt angles θ, whereby component 210, 310 can be used for a plurality of incoming beams 108 at a plurality of tilt angles θ or in a configuration in which y-axis scanning is employed.

It is noted that, at each impingement on the partially-reflective, semi-transparent surface 214, 314, each beam passing through the surface to scanning mirror 110 experiences a drop in optical power. In order to ensure a desired optical power profile of the multiple, i.e., N, parallel beams 223, the semi-transparent coating on surfaces 214, 314 is designed with a spatially varying transmission/reflection ration. For example, if it is desired to have even optical power distribution across all of the output beams 223, the spatial distribution of the coatings across the surfaces 214, 314 can be controlled and customized accordingly.

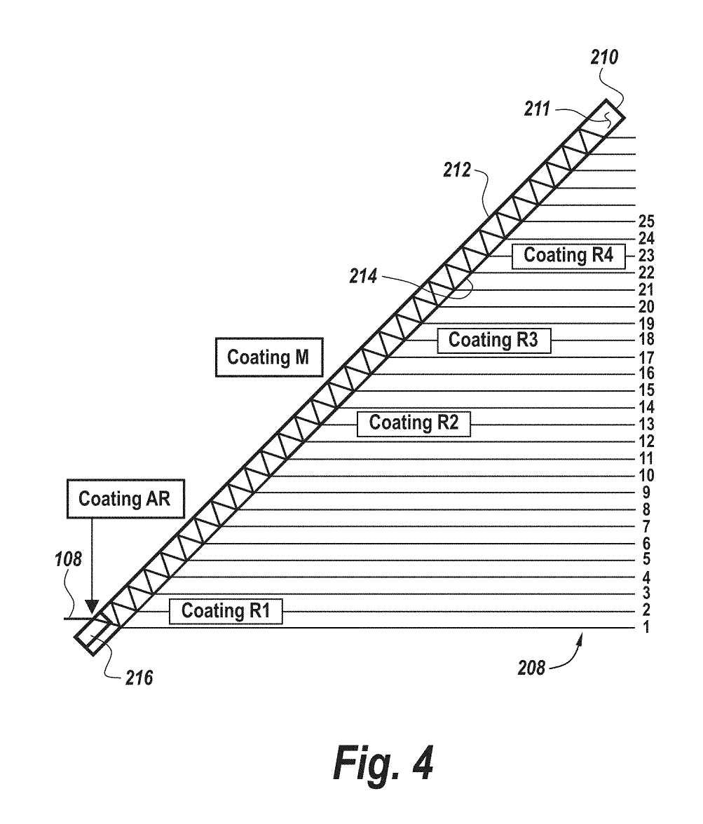

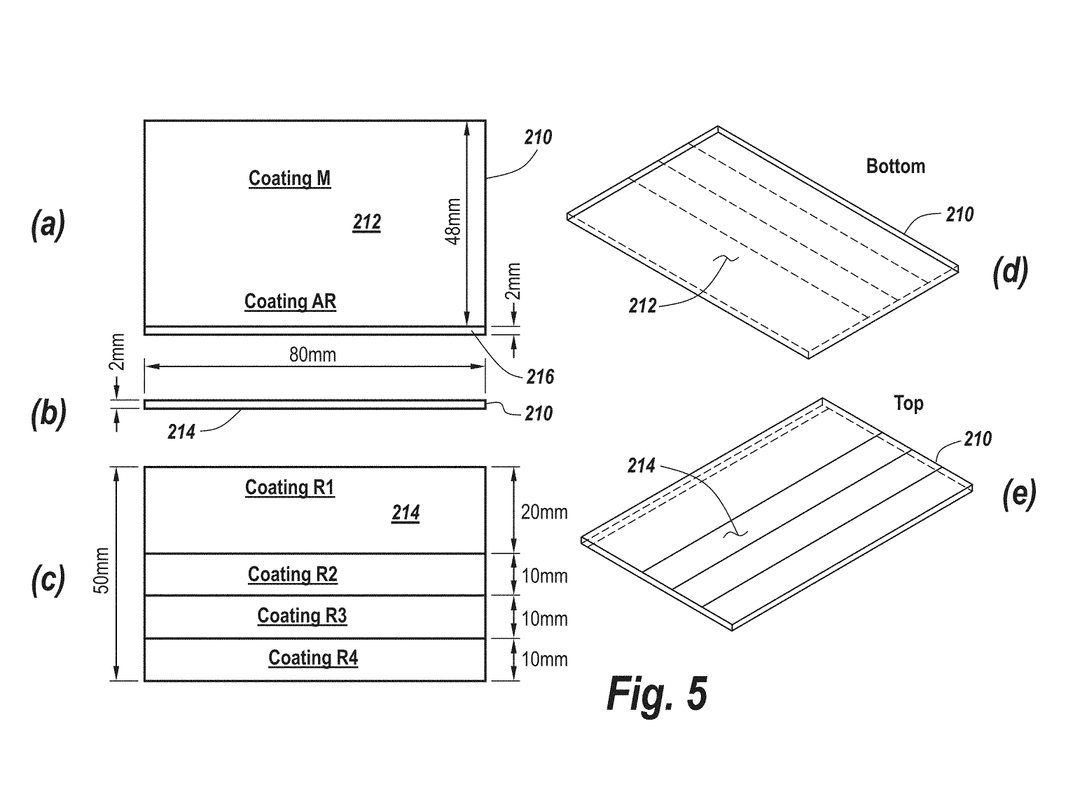

FIG. 4 includes a detailed schematic view of optical component 210 illustrated in FIG. 2, according to some exemplary embodiments. It is noted that the orientation of FIG. 4 is rotated 180 degrees about the vertical axis, compared to that of FIG. 2. FIG. 5 includes multiple views of optical component 210, according to some exemplary embodiments. Specifically, view (a) of FIG. 5 includes a schematic elevational view of “bottom” surface 212 of optical element 210; view (b) of FIG. 5 includes a schematic side view of optical element 210; view (c) of FIG. 5 includes a schematic elevational view of “top” surface 214 of optical element 210; view (d) of FIG. 5 includes a schematic perspective view of optical element 210 from the bottom; and view (e) of FIG. 5 includes a schematic perspective view of optical element 210 from the top. It should be noted that the dimensions shown in FIG. 5 are exemplary only and are included to provide context, perspective and clarity. The present disclosure is applicable to any desired dimensions.

Referring to FIGS. 4 and 5, bottom surface 212 of optical component 210 includes a first portion including an anti-reflective coating, identified as “Coating AR,” which defines transparent opening or port 216 through which beam 108 enters optical component 210. The remainder of bottom surface 212 is completely reflective and, therefore, includes a mirror coating, identified as “Coating M.” Top surface 214 of optical component 210 includes multiple coatings disposed along surface 214 as shown. In this particular illustrative exemplary embodiment, four coatings, identified as “Coating R1,” “Coating R2,” “Coating R3,” and “Coating R4,” are shown. It will be understood that, based upon the desired output beam 208 power profile, any number of coatings or a continuously varying coating may be used. Each of the coatings on top surface 214 has a different reflectivity, which is selected such that the desired output beam 208 power profile is obtained.

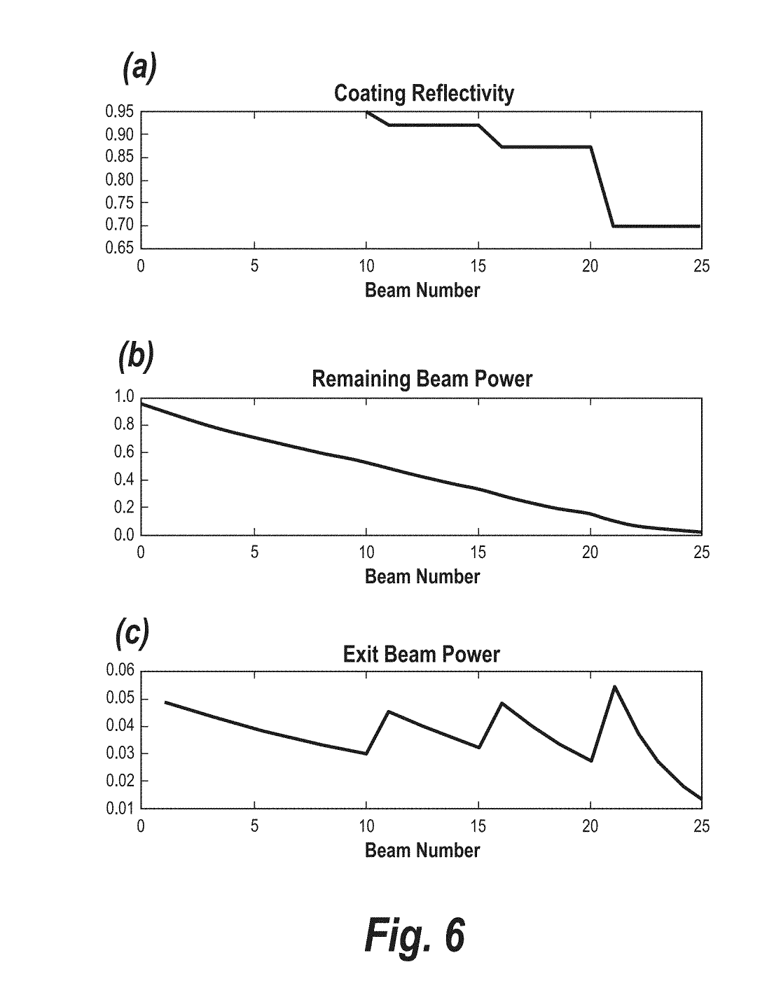

FIG. 6 includes three curves illustrating an exemplary normalized coating reflectivity profile on top surface 214 of optical element 210 (curve a), normalized beam power remaining after reflection from top surface 214 (curve b), and normalized exit beam power (curve c) for each of 25 beams 208 generated by optical element 210, according to beam number, from 1 to 25, according to some exemplary embodiments. It will be understood that 25 beams affected by four coatings are used for the exemplary illustration of FIGS. 4-6. According to the present disclosure, any number of beams and/or coatings can be used.

Referring to FIGS. 4-6, the reflectivity of Coating R1 determines exit beam power and remaining beam power associated with beams 1-10. Similarly, the reflectivity of Coating R2 determines exit beam power and remaining beam power associated with beams 11-15; the reflectivity of Coating R3 determines exit beam power and remaining beam power associated with beams 16-20; and the reflectivity of Coating R4 determines exit beam power and remaining beam power associated with beams 21-25. Hence, the coatings Coating R1, Coating R2, Coating R3, and Coating R4 are selected such that their respective reflectivities provide the desired output beam 208 power profile.

FIGS. 4-6 illustrate the effect of the various selected coatings on generation of the desired output beam power profile, using optical element of FIG. 2 for purposes of illustration. It will be understood that FIGS. 4-6 and the foregoing detailed description thereof are also applicable to optical element 310 illustrated in FIG. 3. That is, referring to FIGS. 3-6, Coating AR can be applied to optical surface 312 to create transparent opening or port 316 in optical surface 312, and Coating M can be applied to the remaining surface of optical surface 312. Similarly, coatings Coating R1, Coating R2, Coating R3, and Coating R4 can be applied to optical surface 314 create a specially-coated semi-transparent window to obtain the desired output beam 208 power profile according to the curves (a)-(c) of FIG. 6.

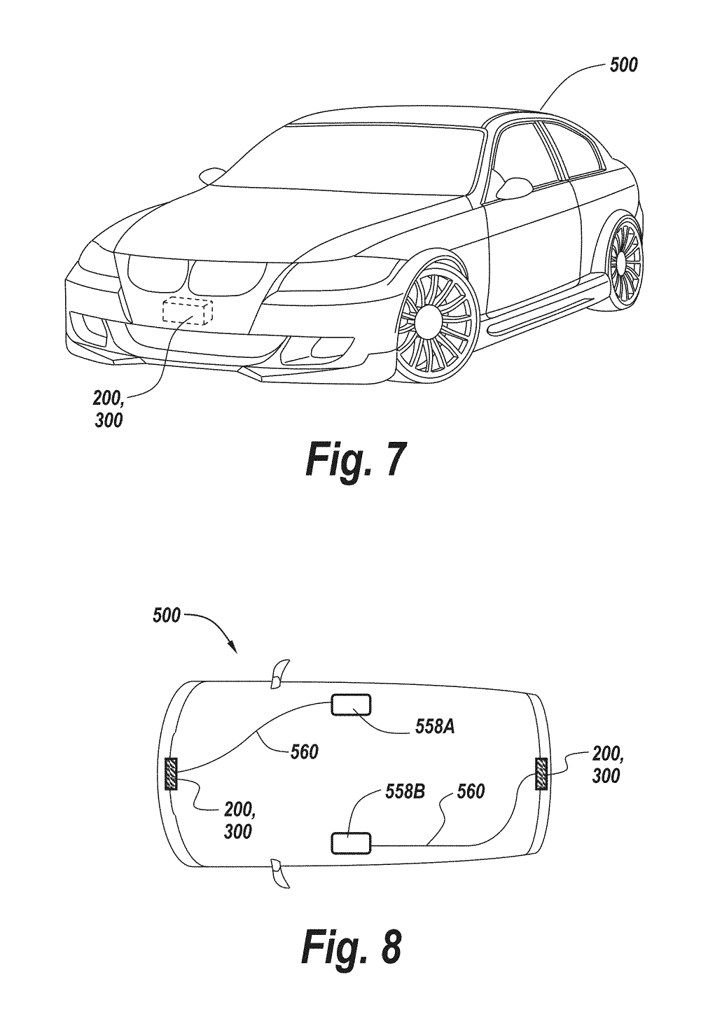

FIG. 7 includes a schematic perspective view of an automobile 500, equipped with one or more scanning LiDAR systems 200, 300, described herein in detail, according to exemplary embodiments. Referring to FIG. 7, it should be noted that, although only a single scanning LiDAR system 200, 300 is illustrated, it will be understood that multiple LiDAR systems 200, 300 according to the exemplary embodiments can be used in automobile 500. Also, for simplicity of illustration, scanning LiDAR system 200, 300 is illustrated as being mounted on or in the front section of automobile 500. It will also be understood that one or more scanning LiDAR systems 200, 300 can be mounted at various locations on automobile 500.

FIG. 8 includes a schematic top view of automobile 500 equipped with two scanning LiDAR systems 200, 300, as described above in detail, according to exemplary embodiments. In the particular embodiments illustrated in FIG. 8, a first LiDAR system 200, 300 is connected via a bus 560, which in some embodiments can be a standard automotive controller area network (CAN) bus, to a first CAN bus electronic control unit (ECU) 558A. Detections generated by the LiDAR processing described herein in detail in LiDAR system 200, 300 can be reported to ECU 558A, which processes the detections and can provide detection alerts via CAN bus 560. Similarly, in some exemplary embodiments, a second LiDAR scanning system 200, 300 is connected via CAN bus 560 to a second CAN bus electronic control unit (ECU) 558B. Detections generated by the LiDAR processing described herein in detail in LiDAR system 200, 300 can be reported to ECU 558B, which processes the detections and can provide detection alerts via CAN bus 560. It should be noted that this configuration is exemplary only, and that many other automobile LiDAR configurations within automobile 500 can be implemented. For example, a single ECU can be used instead of multiple ECUs. Also, the separate ECUs can be omitted altogether.

It is noted that the present disclosure describes one or more scanning LiDAR systems installed in an automobile. It will be understood that the embodiments of scanning LiDAR systems of the disclosure are applicable to any kind of vehicle, e.g., bus, train, etc. Also, the scanning LiDAR systems of the present disclosure need not be associated with any kind of vehicle.

Whereas many alterations and modifications of the disclosure will become apparent to a person of ordinary skill in the art after having read the foregoing description, it is to be understood that the particular embodiments shown and described by way of illustration are in no way intended to be considered limiting. Further, the subject matter has been described with reference to particular embodiments, but variations within the spirit and scope of the disclosure will occur to those skilled in the art. It is noted that the foregoing examples have been provided merely for the purpose of explanation and are in no way to be construed as limiting of the present disclosure.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

1. A LiDAR detection system, comprising:
an optical source for providing a first beam of light;
a beam splitting device for receiving the first beam of light and generating a plurality of second beams of light from the first beam of light, the plurality of second beams of light being disposed along a first lateral direction and being transmitted into a region, the beam splitting device comprising a first surface and a second surface, the first surface reflecting a first portion of the first beam of light toward the second surface and transmitting a second portion of the first beam through a first position of the first surface such that the second portion of the first beam becomes one of the plurality of second beams of light, the first portion of the first beam of light being reflected from the second surface toward the first surface, the first surface splitting the first portion of the first beam of light into third and fourth portions, the first surface reflecting the third portion toward the second surface and transmitting the fourth portion through a second laterally shifted position of the first surface such that the fourth portion becomes another of the plurality of second beams of light;
a scanning device for scanning the plurality of second beams of light over a second direction different than the first direction;
a receiver for receiving reflected optical signals generated by reflection of one or more of the second beams of light and generating receive signals indicative of the reflected optical signals; and
a processor coupled to the receiver for receiving the receive signals and processing the receive signals to generate detections of one or more objects in the region.

2. The LIDAR detection system of claim 1, wherein the first and second surfaces are substantially parallel.

3. The LiDAR detection system of claim 1, wherein the plurality of second beams of light are substantially mutually parallel.

4. The LiDAR detection system of claim 1, wherein a propagation axis of the first beam of light forms a tilt angle with the beam splitting device, the tilt angle being selectable to set a predetermined spacing between the plurality of second beams of light.

5. The LiDAR detection system of claim 1, wherein a spacing distance between the first and second surfaces is selectable to set a predetermined spacing between the plurality of second beams of light.

6. The LiDAR detection system of claim 1, wherein reflectivity of the first surface varies by position on the first surface.

7. The LiDAR detection system of claim 2, wherein the first surface includes a plurality of optical coatings.

8. The LiDAR detection system of claim 3, wherein one or more parameters of the plurality of optical coatings vary by position to achieve a desired reflectivity variation of the first surface by position on the first surface.

9. The LiDAR detection system of claim 1, wherein the second surface comprises a first portion that is substantially completely transparent and a second portion that is substantially completely reflective.

10. The LiDAR detection system of claim 1, wherein the first and second surfaces are formed on a single substrate.

11. The LiDAR detection system of claim 10, wherein at least one of the first and second surfaces comprises one or more optical coatings.

12. The LiDAR detection system of claim 10, wherein the single substrate is substantially optically transparent.

13. The LiDAR detection system of claim 10, wherein the single substrate comprises glass.

14. The LiDAR detection system of claim 10, wherein the single substrate comprises fused silica.

15. The LiDAR detection system of claim 1, wherein the first direction is substantially orthogonal to the second direction.

16. The LiDAR detection system of claim 1, wherein the scanning device comprises a scanning mirror.

17. The LiDAR detection system of claim 16, wherein the scanning mirror is a micro-electromechanical system (MEMS) scanning mirror.

18. The LiDAR detection system of claim 1, wherein the receiver comprises an array of optical detectors.

19. The LiDAR detection system of claim 18, wherein the array of optical detectors is a two-dimensional array.

20. The LiDAR detection system of claim 1, wherein the optical source comprises a laser.

21. The LiDAR detection system of claim 1, wherein the LIDAR detection system is an automotive LiDAR detection system.
